(19) United States
(12) Patent Application Publication
(10) Pub. No.: US 2009/0077430 A1
(43) Pub. Date: Mar. 19, 2009

(54) HYBRID AUTOMATIC REPEAT REQUEST APPARATUS AND METHOD FOR ALLOCATING PACKET-BASED FIXED RESOURCES IN A WIRELESS MOBILE COMMUNICATION SYSTEM

(75) Inventors: Min-Hee CHO, Suwon-si (KR); Jae-Hee CHO, Seoul (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/190,253

(22) Filed: Aug. 12, 2008

(30) Foreign Application Priority Data
Aug. 29, 2007 (KR) 2007-87080

(51) Int. Cl. H04L 1/18; G06F 11/10; G06F 11/07

(52) U.S. Cl. 714/701; 714/748; 714/E11.032; 714/E11.029

(57) ABSTRACT

An apparatus and method for preventing errors in an HARQ operation and improving HARQ performance are provided. In the apparatus and method, upon receipt of HARQ feedback information, an information interpreter interprets the HARQ feedback information and determines whether the HARQ feedback information includes an error. If the HARQ feedback information includes an error, a scheduler controls a data pattern with the receiver to be generated.

### PRIORITY

This application claims the benefit under 35 U.S.C. § 119(a) of a Korean patent application filed in the Korean Intellectual Property Office on Aug. 29, 2007 and assigned Serial No. 2007-87080, the entire disclosure of which is hereby incorporated by reference.

### BACKGROUND OF THE INVENTION

1. Field of the Invention

The present invention relates to a Hybrid Automatic Repeat reQuest (HARQ) apparatus and method for allocating circuit-mode resources in a wireless communication system. More particularly, the present invention relates to an HARQ apparatus and method for enhancing HARQ performance in the case where packet-based circuit-mode resources are allocated.

2. Description of the Related Art

During the early development of communication systems, the primary focus was on the provision of voice services. Now, as communication systems are maturing, they are under development to additionally provide data service and a variety of multimedia services. Moreover, a pressing need has arisen for a communication system that can efficiently provide Internet services. However, due to a relatively narrow transmission bandwidth and an expensive charge rate, voice-oriented communication systems are limited in meeting the increasing user demands. In this context, a Broadband Wireless Access (BWA) system has been introduced to provide the Internet service efficiently by using a band wide enough to satisfy the increasing user demands.

The BWA communication system aims to support both low-rate and high-rate data services and multimedia application services. For example, the BWA communication system supports services such as high-quality moving pictures as well as voice service in an integrated fashion. Such a BWA system allows access to Public Switched Telephone Networks (PSTN), Public Switched Data Networks (PDSN), the Internet, International Mobile Telecommunications 2000 (IMT 2000) networks, and Asynchronous Transfer Mode (ATM) networks. The BWA system accesses these networks by means of a wireless medium using wide bands of 2, 5, 26 and 60 GHz in a mobile or fixed environment. It can also support channel transmission rates of 2 Mbps or higher. BWA networks can be categorized into a broadband wireless subscriber network, a broadband mobile access network, and a high-speed Wireless Local Area Network (WLAN) according to terminal mobility (fixed or mobile), communication environment (indoor or outdoor), and channel transmission rate.

The wireless access technology of the BWA system is standardized in Institute of Electrical and Electronics Engineers (IEEE) 802.16 to 802.20 working groups.

Compared to conventional voice-oriented wireless technology, the BWA standards have several advantages. For example, the BWA standards make it possible to transmit a large volume of data for a short time due to a wide bandwidth for data transmission and to efficiently use channels (or resources) by sharing them among all users. In addition, since Quality of Service (QoS) is guaranteed, services with different QoS requirements can be provided to users according to their service characteristics.

The IEEE 802.16 to 802.20 communication systems adopt Orthogonal Frequency Division Multiplexing/Orthogonal Frequency Division Multiple Access (OFDM/OFDMA) for physical channels. That is, the BWA systems enable high-speed data transmission by transmitting a physical channel signal on a plurality of subcarriers in OFDM/OFDMA.

To efficiently provide a periodic service such as Voice over Internet Protocol (VoIP) over an IEEE 802.16 to 802.20-like packet-based mobile communication network, it is necessary to reduce the overhead of frequent resource allocations and releases. For this purpose, continuous use of allocated resources for a preset time period or until the resources are released, i.e. a circuit-mode service, should be introduced, rather than resources being allocated whenever data is transmitted. An example of the circuit-mode service is sticky allocation used in an IEEE 802.20 Mobile BWA (MBWA) system.

Conventionally, when circuit-mode resource allocation and HARQ are performed together, in uplink transmission for example, a Base Station (BS) transmits to a Mobile Station (MS) an ACKnowledgment (ACK) or a Negative ACKnowledgment (NACK) for an HARQ packet received from the MS. The ACK/NACK is transmitted in a broadcast message. Upon receipt of an ACK, the MS transmits a new HARQ packet and upon receipt of a NACK, it retransmits the previously transmitted HARQ packet. If the broadcast message has an error such as a Cyclic Redundancy Check (CRC) error, the MS fails to receive the ACK/NACK and does not know which packet to transmit.

If the MS transmits a new HARQ packet despite NACK transmission from the BS, the BS, considering that the HARQ packet is a retransmitted one, attempts to combine the received HARQ packet with a previous received packet. The resulting reception failure makes the BS transmit a NACK again. Such a packet reception error and retransmission consumes resources. In the case where the BS transmits an ACK but the MS retransmits the previously transmitted packet, the BS erroneously believes that the received packet is a new one. In Incremental Redundancy (IR) HARQ, a reception error may occur because a new packet and a retransmitted packet have different subpacket Identifiers (IDs). As described above, when a transmitter's intention does not coincide with a receiver's interpretation, retransmission and packet reception errors occur many times, resulting in unnecessary consumption of radio resources.

In the conventional packet-based wireless mobile communication systems, there is no substantial discussion of using a circuit mode for providing a periodic service like VoIP and performing an HARQ operation in the circuit mode. That is, when a signal detection error occurs in an HARQ feedback signal (e.g. ACK or NACK), malfunction or performance degradation may result. Accordingly, there is a need for a technique for preventing performance degradation caused by an abnormal HARQ operation in a circuit mode and effectively performing an HARQ operation in a packet-based wireless mobile communication system.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for preventing radio resource consumption by preventing a packet reception error caused by non-reception or failed reception of an HARQ feedback (AKC/NACK) message and the resulting retransmission, when an HARQ operation is performed along with packet-based fixed resource allocation or packet-based circuit-mode resource allocation.

Another aspect of the present invention is to provide an apparatus and method for improving HARQ performance when fixed resources are allocated in a packet-based wireless mobile communication system.

A further aspect of the present invention is to provide an apparatus and method for reducing HARQ errors when fixed resources are allocated in a packet-based wireless mobile communication system.

In accordance with an aspect of the present invention, an apparatus for transmitting an HARQ burst is provided. The apparatus includes an information interpreter which, upon receipt of HARQ feedback information, interprets the HARQ feedback information and determines whether the HARQ feedback information includes an error, and if the HARQ feedback information includes an error, a scheduler controls a data pattern to be generated.

In accordance with another aspect of the present invention, an apparatus for receiving an HARQ burst is provided. The apparatus includes a burst processor for receiving a burst from a transmitter and for determining whether the received burst is of a data pattern, and a scheduler for controlling previously transmitted HARQ feedback information to be retransmitted, if the received burst is of the data pattern. In one implementation, the HARQ feedback information indicates whether reception of an HARQ packet received from the transmitter previously to the data pattern is successful.

In accordance with a further aspect of the present invention, a method for transmitting an HARQ burst is provided. The method includes, upon receipt of HARQ feedback information indicating whether a receiver has succeeded in receiving a previously transmitted HARQ packet from the receiver, the HARQ feedback information is interpreted, it is determined whether the HARQ feedback information includes an error, and a data pattern with the receiver is transmitted, if the HARQ feedback information includes an error.

In accordance with still another aspect of the present invention, a method for receiving an HARQ burst is provided. The method includes, upon receipt of a burst from a transmitter, determining whether the received burst is of a data pattern, and retransmitting previously transmitted HARQ feedback information if the received burst is of the data pattern. In an exemplary implementation, the HARQ feedback information indicates whether reception of an HARQ packet received from the transmitter previously to the data pattern is successful.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating an HARQ operation in a circuit mode according to an exemplary embodiment of the present invention;

FIG. 2 is a block diagram of a data burst receiver according to an exemplary embodiment of the present invention;

FIG. 3 is a block diagram of a data burst transmitter according to an exemplary embodiment of the present invention;

FIG. 4 is a flowchart illustrating a data burst reception operation of a data burst receiver according to an exemplary embodiment of the present invention; and

FIG. 5 is a flowchart illustrating a data burst transmission operation of a data burst transmitter according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a technique for HARQ feedback in the case of packet-based fixed resource allocation.

While the following examples of the present invention are described in the context of an OFDM BWA communication system, it is to be understood that the present invention is also applicable to any packet-based communication system.

In accordance with exemplary embodiments of the present invention, when an HARQ packet transmitter determines an error in a message including an HARQ feedback (ACK/NACK) received from an HARQ packet receiver, the HARQ packet transmitter can transmit a data pattern to the HARQ packet receiver. Determining that the HARQ feedback message has a reception error, the HARQ packet receiver may retransmit the HARQ feedback message. Hence, the conventional problem of transmitting an HARQ feedback message repeatedly between a transmitter and a receiver, caused by the transmitter's transmission of new data or retransmission of transmitted data according to its own decision, can be solved. The data pattern may include a pattern in which an HARQ packet can be transmitted at a lower power level than a normal HARQ packet.

In an uplink circuit mode, a BS transmits an HARQ feedback (ACK/NACK) in a broadcast message to an MS. If a reception error occurs to the broadcast message, the HARQ feedback reception is failed. On the other hand, in a downlink circuit mode, an MS usually transmits an HARQ feedback (ACK/NACK) to a BS on an allocated retransmission response channel (ACK channel). The BS performs erasure detection based on the Carrier-to-Interference and Noise Ratio (CINR) of the HARQ feedback and, if determining that the erasure-detected feedback information is not valid, the BS determines that the HARQ feedback reception has failed. Except for this difference, the downlink and uplink operations are similar. While the following description is made of an operation in the uplink fixed-resource allocation mode or in the uplink circuit mode as an exemplary embodiment of the present invention, it is to be clearly understood that the same thing applies to an operation in the downlink circuit mode.

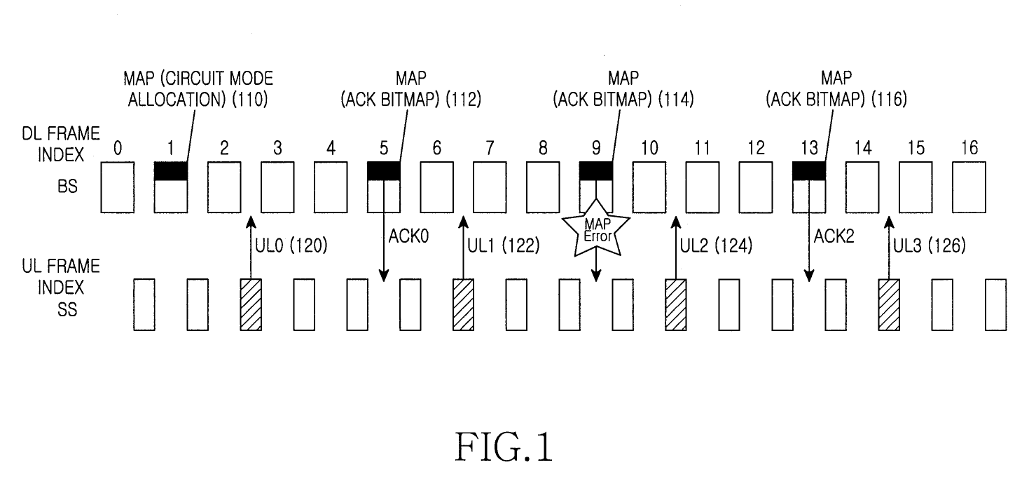

FIG. 1 is a diagram illustrating an HARQ operation in a circuit mode according to an exemplary embodiment of the present invention.

Referring to FIG. 1, a BS carries out a circuit-mode resource allocation by broadcasting a resource allocation Media Access Protocol (MAP) message in step 110. Then, an MS periodically transmits uplink HARQ packets in steps 120, 122, 124 and 126. For sake of explanation and convenience, it is assumed herein that the MS transmits uplink HARQ packets every four frames to the BS. However, this is merely an example. The BS transmits an ACK/NACK for the HARQ packet transmitted in step 120 to the MS by a broadcast message in step 112. When the MS receives an ACK that was transmitted in step 112, it transmits a new HARQ packet to the BS in step 122. If the MS receives a NACK that was transmitted in step 112, it retransmits the transmitted HARQ packet to the BS in step 122. If the broadcast message including an ACK/NACK transmitted from the BS in step 114 has an error, the MS determines if errors exist in the broadcast message by a CRC check and transmits a data pattern to the BS in step 124. For example, the data pattern can be a 1-bit pattern. The data pattern is transmitted at a lower power level than a normal HARQ packet, thus contributing to reduction of interference at the receiver. After receiving the data pattern, the BS retransmits the ACK/NACK transmitted in step 114 to the MS in step 116. If the MS receives an ACK that was transmitted in step 116, it transmits a new packet to the BS in step 126. If the MS receives a NACK in step 116, it retransmits the HARQ packet transmitted in step 122 to the BS in step 126.

It can be further contemplated as another exemplary embodiment of the present invention that when the HARQ feedback from the BS has an error, the MS transmits no signal during an uplink resource allocation time period in step 124. In this case, the BS detects the power of a received uplink signal and if the detected power is less than a threshold value, it determines that no signal has been received during the resource allocation time period. Since no signal has been received during an HARQ packet reception period, the BS retransmits the ACK/NACK transmitted in step 114 to the MS in step 116. The subsequent steps are performed in the same manner as in the above-described exemplary embodiment of the present invention.

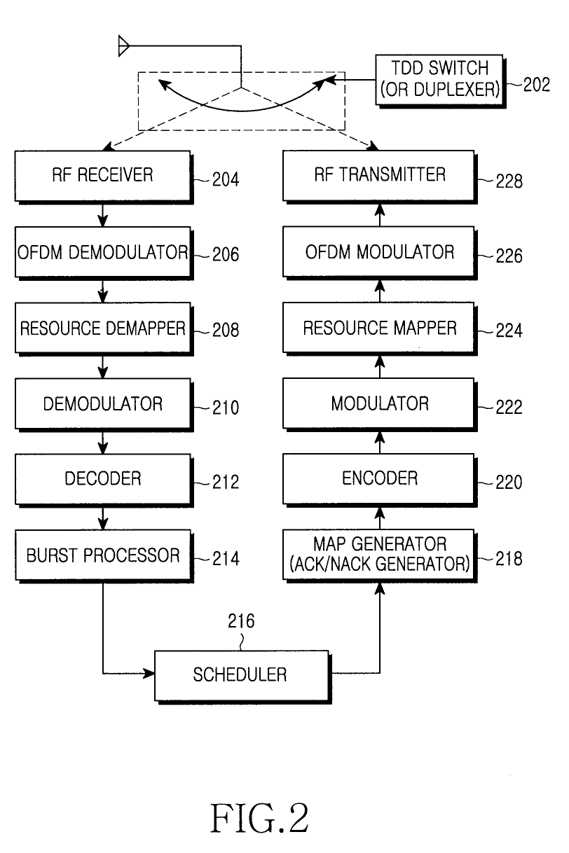

FIG. 2 is a block diagram of a data burst receiver according to an exemplary embodiment of the present invention.

Referring to FIG. 2, a Time Division Duplex (TDD) switch (or a duplexer) 202 switches an HARQ packet received through an antenna to a Radio Frequency (RF) receiver 204.

An OFDM demodulator 206 converts the signal received from the RF receiver 204 into a frequency signal. A resource demapper 208 demaps the frequency signal to interpret the received signal according to a channel and resource allocation scheme. A demodulator 210 demodulates the demapped signal and a decoder 212 deinterleaves and channel-decodes the demodulated signal, thus producing burst data. A burst processor 214 determines whether the HARQ packet reception is successful or failed by a CRC check of the burst data.

A scheduler 216 determines information required to generate a resource allocation broadcast message (MAP message) by downlink/uplink resource allocations scheduling. A MAP generator 218 generates a MAP message including an ACK/NACK according to the success or failure of the HARQ packet reception. An encoder 220 channel-encodes the MAP message and a modulator 222 modulates the channel-coded signal. A resource mapper 224 allocates the modulated signal to at least one subcarrier and OFDM symbol interval according to the channel and resource allocation scheme. An OFDM modulator 226 converts the signal received from the resource mapper 224 to a time signal. The time signal is transmitted through the antenna via an RF transmitter 228 and the TDD switch 202.

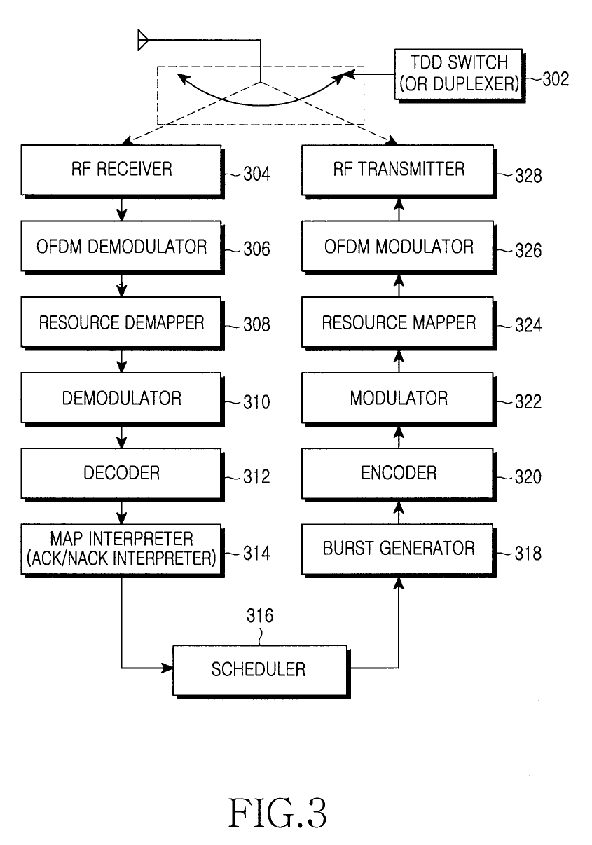

FIG. 3 is a block diagram of a data burst transmitter according to an exemplary embodiment of the present invention.

Referring to FIG. 3, a TDD switch (or duplexer) 302 switches a MAP message received from a BS through an antenna to an RF receiver 304. An OFDM demodulator 306 converts the MAP message into a frequency signal and a resource demapper 308 demaps the frequency signal. The demapped frequency signal may be used to interpret the received signal according to a channel and resource allocation scheme. A demodulator 310 demodulates the demapped signal and a decoder 312 deinterleaves and channel-decodes the demodulated signal, thus producing burst data. A MAP interpreter 314 interprets the MAP message received from the decoder 312 and provides ACK/NACK information to a scheduler 316.

When receiving an ACK, the scheduler 316 transmits new data to a burst generator 318 and the burst generator 318 generates a new HARQ packet. When receiving a NACK, the scheduler 316 notifies the burst generator 318 of retransmission and the burst generator 318 generates a retransmission packet. If an error, for example, a CRC error is detected in the MAP message, the burst generator 318 generates a data pattern and provides the data pattern to an encoder 320.

The encoder 320 channel-encodes the burst (or signal) received from the burst generator 318 and a modulator 322 modulates the channel-coded signal. A resource mapper 324 allocates the modulated signal to at least one subcarrier and OFDM symbol interval according to the channel and resource allocation scheme. An OFDM modulator 326 converts the signal received from the resource mapper 324 to a time signal. The time signal is transmitted through the antenna via an RF transmitter 328 and the TDD switch 302.

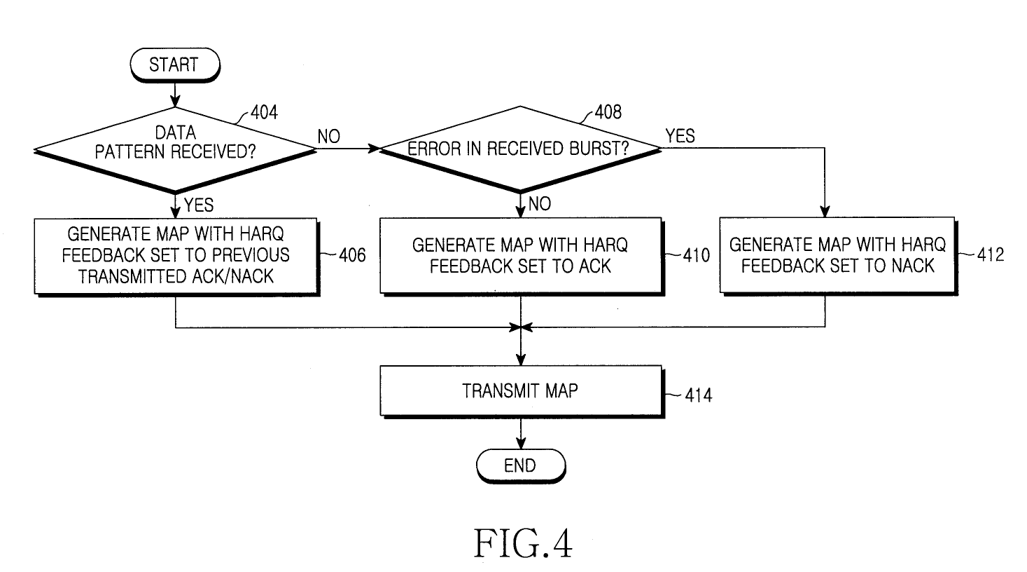

FIG. 4 is a flowchart illustrating a data burst reception operation of a data burst receiver according to an exemplary embodiment of the present invention.

Referring to FIG. 4, a data burst receiver, for example a BS, determines whether a signal received from the MS is of a data pattern indicating HARQ feedback reception failure in step 404. If the received signal is of the data pattern, the BS configures a broadcast message (i.e. MAP) including the previous transmitted ACK/NACK information in step 406 and transmits the MAP message to the MS in step 414.

If it is determined that the received signal is not the data pattern in step 404, the BS demodulates and decodes the burst, considering that the received signal is a normal HARQ packet, and determines if there is an error in the received burst in step 408. If the HARQ packet has been successfully received, that is for example, if the HARQ packet has passed a CRC check, the BS configures a broadcast message, i.e. a MAP message including ACK information, determining that the received burst has no errors in step 410 and transmits the MAP message with the ACK information to the MS in step 414. On the other hand, if the HARQ packet reception is failed, that is for example, the HARQ packet has a CRC error in step 408, the MS configures a broadcast message, i.e. a MAP message including NACK information in step 412 and transmits the MAP message with the NACK information to the MS in step 414.

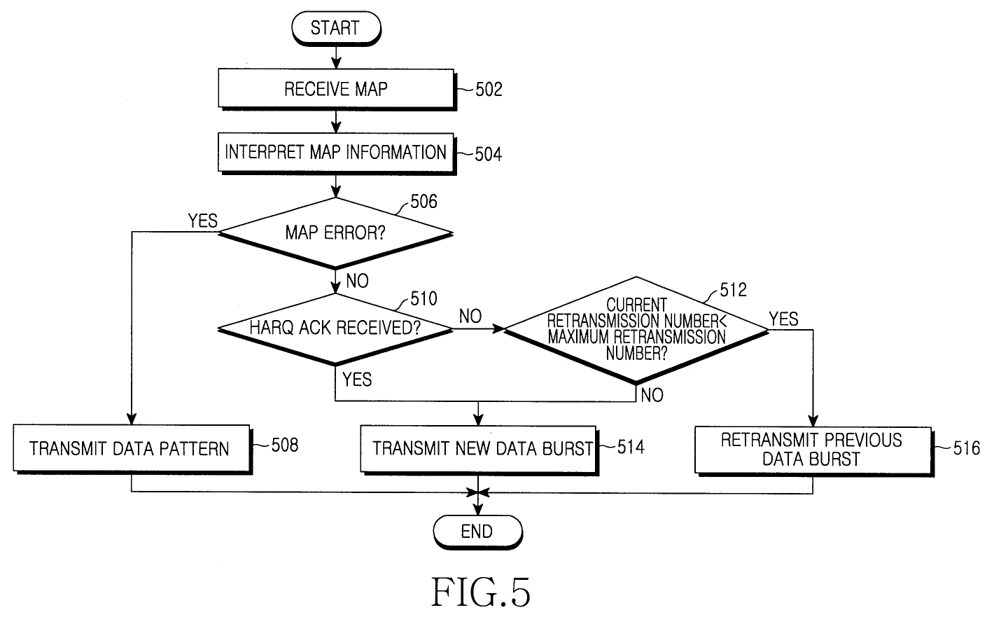

FIG. 5 is a flowchart illustrating a data burst transmission operation of a data burst transmitter according to an exemplary embodiment of the present invention.

Referring to FIG. 5, the MS receives (or attempts to receive) a MAP message from the BS during a reception period in step 502. In step 504, the MS interprets the received MAP information. In step 506, the MS determines whether the MAP message has an error. If the MAP message has an error, the MS transmits a data pattern to the BS in step 508. On the other hand, if the MAP message reception is successful, the MS determines whether the MAP information includes an HARQ ACK in step 510. If the HARQ ACK has been received, the MS transmits a new HARQ packet to the BS in step 514. If an HARQ ACK has not been received, the MS determines whether a maximum retransmission number has been exceeded in step 512. If the maximum retransmission number has not been exceeded, the MS retransmits a previous HARQ packet in step 516. If the maximum retransmission number has been exceeded, the MS transmits a new HARQ packet in step 514.

As is apparent from the above description of exemplary embodiments of the present invention, when an HARQ feedback information (ACK/NACK) is not received or has an error during an HARQ operation in a circuit mode, a data pattern is transmitted to indicate the non-reception or error generation of the HARQ feedback information to an HARQ feedback transmitter, and thus the HARQ feedback transmitter retransmits the HARQ feedback information. Therefore, the HARQ feedback retransmission may prevent repeated HARQ packet retransmissions caused by HARQ feedback reception error-incurred wrong packet transmission and the resulting continuous packet reception errors, and thus may reduce radio resource consumption. Also, the present invention may reduce a packet transmission delay and increase system transmission capacity.

While the invention has been shown and described with reference to certain exemplary embodiments, they are merely exemplary applications. For example, while the exemplary embodiments of the present invention have been described in the context of an MS being an HARQ packet transmitter and a BS being an HARQ packet receiver, that is, in the context of uplink transmission, the present invention is also applicable to downlink HARQ packet transmission and reception. In addition, when a reception error occurs to an HARQ feedback signal, no signal can be transmitted during a transmission period, rather than a signal is transmitted, so that the transmitter can indicate reception failure of a transmitted HARQ feedback signal to the receiver. Therefore, it will be understood by those skilled in the art that various changes in form and details may be made therein without departing from the spirit and scope of the present invention as defined by the appended claims and their equivalents.

What is claimed is:

1. An apparatus for transmitting a Hybrid Automatic Repeat reQuest (HARQ) burst, the apparatus comprising:
an information interpreter for, upon receipt of HARQ feedback information, interpreting the HARQ feedback information and determining whether the HARQ feedback information has a reception error; and
a scheduler for, if the HARQ feedback information has a reception error, controlling the generation of a data pattern.

2. The apparatus of claim 1, wherein the HARQ feedback information indicates whether a receiver has succeeded in receiving a previously transmitted HARQ packet.

3. The apparatus of claim 1, further comprising a burst generator for generating a data burst according to the data pattern when the data pattern is generated.

4. The apparatus of claim 1, wherein the data pattern indicates at least one of a reception failure of the HARQ feedback information and a presence of an error in the HARQ feedback information.

5. The apparatus of claim 4, wherein the error comprises a Cyclic Redundancy Check (CRC) error.

6. The apparatus of claim 1, wherein the data pattern comprises a pattern in which an HARQ packet following the previously transmitted HARQ packet is transmitted at a lower power level than the previously transmitted HARQ packet.

7. An apparatus for receiving a Hybrid Automatic Repeat reQuest (HARQ) burst, the apparatus comprising:
a burst processor for receiving a burst from a transmitter and for determining whether the received burst comprises a data pattern; and
a scheduler for controlling previously transmitted HARQ feedback information to be retransmitted, if the received burst comprises the data pattern,
wherein the HARQ feedback information indicates whether reception of an HARQ packet received from the transmitter previously to the data pattern is successful.

8. The apparatus of claim 7, further comprising a burst generator for generating a MAP message including HARQ feedback information.

9. The apparatus of claim 8, wherein the data pattern indicates at least one of reception failure of the previously transmitted HARQ feedback information and presence of a Cyclic Redundancy Check (CRC) error in the previous transmitted HARQ feedback information.

10. The apparatus of claim 7, wherein the data pattern comprises a pattern in which an HARQ packet following the previously transmitted HARQ packet is transmitted at a lower power level than the previously transmitted HARQ packet.

11. A method for transmitting a Hybrid Automatic Repeat reQuest (HARQ) burst, the method comprising:
interpreting, upon receipt of HARQ feedback information, the HARQ feedback information;
determining whether the HARQ feedback information has a reception error; and
transmitting a data pattern if the HARQ feedback information has a reception error.

12. The method of claim 11, wherein the HARQ feedback information indicates whether a receiver has succeeded in receiving a previously transmitted HARQ packet.

13. The method of claim 11, further comprising:
generating a new data burst if the HARQ feedback information does not have a reception error and the HARQ feedback information comprises an ACKnowledgment (ACK); and
comparing a retransmission number with a maximum retransmission number if the HARQ feedback information does not include the error and the HARQ feedback information is a Negative ACKnowledgment (NACK).

14. The method of claim 13, further comprising:
retransmitting a previous data burst, if the retransmission number is equal to or less than the maximum retransmission number; and
transmitting a new data burst, if the retransmission number is larger than the maximum retransmission number.

15. The method of claim 11, wherein the data pattern indicates at least one of reception failure of the HARQ feedback information and presence of a Cyclic Redundancy Check (CRC) error in the HARQ feedback information.

16. The method of claim 11, wherein the data pattern comprises a pattern in which an HARQ packet following the previously transmitted HARQ packet is transmitted at a lower power level than the previously transmitted HARQ packet.

17. A method for receiving a Hybrid Automatic Repeat reQuest (HARQ) burst, the method comprising:
determining, upon receipt of a burst from a transmitter, whether the received burst comprises a data pattern; and
retransmitting previously transmitted HARQ feedback information, if the received burst comprises the data pattern,
wherein the HARQ feedback information indicates whether reception of an HARQ packet received from the transmitter previously to the predefined data pattern is successful.

18. The method of claim 17, further comprising;
if the received burst does not comprise the data pattern, determining whether the received burst has an error, configuring HARQ feedback information to comprise an ACKnowledgment (ACK), and transmitting a MAP message including the HARQ feedback information; and
if the received burst has an error, configuring HARQ feedback information to comprise a Negative ACKnowledgment (NACK), and transmitting a MAP message including the HARQ feedback information.

19. The method of claim 17, wherein the data pattern indicates at least one of reception failure of the previously transmitted HARQ feedback information in the transmitter and presence of a Cyclic Redundancy Check (CRC) error in the previously transmitted HARQ feedback information.

20. The method of claim 17, wherein the data pattern comprises a pattern in which an HARQ packet following the previously transmitted HARQ packet is transmitted at a lower power level than the previously transmitted HARQ packet.
